(19) United States
(12) Patent Application Publication
(10) Pub. No.: US 2009/0272037 A1
(43) Pub. Date: Nov. 5, 2009

(54) JALOUSIE WINDOW WITH INSULATING LOUVERS

(75) Inventor: Jesus M. Sosa, Rio Piedras, PR (US)

Correspondence Address: DUANE MORRIS LLP - Philadelphia;IP DEPARTMENT, 30 SOUTH 17TH STREET, PHILADELPHIA, PA, 19103-4196, US

(73) Assignee: Vent-Alarm Corporation, Gurabo, PR (US)

(21) Appl. No.: 12/113,676

(22) Filed: May 1, 2008

(51) Int. Cl. E06B 7/08; E06B 9/01

(52) U.S. Cl. 49/74.1; 160/236

(57) ABSTRACT

An insulative window assembly has a frame carrying a window pane closure and also a thermally insulative jalousie structure that when closed confines an air space with the window pane closure. The slats can be glass or opaque bodies that are molded or have casings carrying a foam, particulate or other insulation. Complementary edges of the slats seal and mechanically engage when closed. The pivot axes for the slats can be adjacent a lateral edge of the slats to cause the slats to cantilever from their pivots axes when open, for shading from the sun.

### FIELD OF THE INVENTION

The invention relates to window structures, and in particular concerns a building exterior window assembly having jalousie slats or louvers configured for thermal insulation and sun shading. The slats lap one another when closed and can be spaced from a window pane or sash so as to confine an air space.

### BACKGROUND

A building window typically comprises a rectangular frame, often constructed from extruded lengths of metal or polymer or another material. The frame is arranged in an opening in a building wall having a given depth or wall thickness, and the frame carries a glass unit. In some windows, the glass is stationary and seals the opening. Advantageously, however, the glass unit can comprise a fixed pane and an overlapping movable sash pane, or two slidably overlapping sashes, one or more hinged casements, pocket panels or another movable structure by which the window is opened or shut selectively, namely by adjusting the position of its movable parts relative to the frame.

Windows have several useful aspects. These include, at least, admitting or blocking light and viewing, admitting or blocking air circulation, thermal insulation (conductive, convective and/or radiant) when closed, capacity to block rain or other precipitation or dampness, security against unauthorized entry or exit, etc. A window may be more or less effective for these particular functions due to the specific structure chosen. There are tradeoffs.

Windows also have important aesthetic effects. The size and character of an exterior window can vary the perceptions of those in a room in a building and those who view the window from the exterior. From the interior, for example, different sizes and structural arrangements can carry different impressions with respect to privacy and security versus public exposure, warmth in a cold climate or comfortable coolness in a hot climate. From the exterior, windows vary from welcoming expansive openings to forbidding security arrangements.

Among possible window structures, the jalousie type window comprises a plurality of slats or louvers that are mounted on parallel spaced pivot axes. Some examples of jalousie structures with louver mounting and pivoting mechanisms are disclosed in U.S. Pat. Nos. 6,061,962 and 5,907,926. These patents are incorporated by reference in this disclosure.

Typically the pivot axes of the slats are horizontal but they can be vertical instead. The slats are ganged by a linkage mechanism causing the slats to pivot open or closed in unison. Jalousies can have security benefits because the spacing between the slats is typically too small to admit an intruder in any pivot position of the slats. The slats can be pivoted into a position at least partly perpendicular to the plane of the building wall. When fully perpendicular, planar slats occupy the minimum cross sectional area obstructing air flow or view. Wholly planar parallel slat structures might be sized and spaced so as to pivot into a common plane when closed. Often the slats are configured to overlap at their edges when closed. In order to seal closed against the passage of air, the edges of the slats can have seals and/or can be shaped with stepped edges that are complementary to the shape of an adjacent slat. Slats may comprise sheet material that is flat, or curved across a lateral cross section. A curve tends to contribute stiffness. Slats may have that vary in thickness across a lateral cross section in a diamond or lozenge or other shape. These variations from a thin flat planar slat shape increase the apparent slat thickness when the slats are fully open.

The jalousie slats can comprise clear glass, colored or translucent glass, or an opaque material such as sheet metal, wood or plastic, or painted or covered glass. Clear glass is desirable for viewing when opened or closed. Opacity is desirable for privacy when closed. A sheet metal material provides security.

Among other possible variations, the slats of a jalousie window can be relatively wider or narrower in a lateral direction perpendicular to the slat pivot axis, and might be centered and balanced on the pivot axis or off-center so as to cantilever when open. A smaller number of wider slats can encompass the same size window opening as a greater number of narrower slats, regardless of the relative placement of the pivot axis. But when the slats are opened, different arrangements produce different effects, for example as to sun shading, slat position and span of displacement of the slat edges in a direction perpendicular to the plane of the window, etc.

In a situation where there is a temperature difference between opposite sides of a window structure (indoors versus outdoors), the glass portion of the window and the supporting frame conduct heat energy; the glass passes radiant heat; and any unsealed openings permit convection. Heat may be conducted from the warm interior of a room to cooler air outside; or, heat from a warm exterior of a building may be conducted into an air conditioned or other room that is desired to be maintained at a temperature cooler than the exterior air. On the other hand, even when there is a temperature difference, it may be desirable (or undesirable) in some instances not only that some heat energy is transmitted, but to encourage energy transfer in one direction or the other. An example is to admit sunshine through the window of a heated space on a cold day. What is needed is an optimal way to control the open and closed and light and heat transmission aspects of a window structure.

Design choices made to maximize the openness of window structures for view and air circulation, when desired, are generally inconsistent with the choices that might be made to minimize heat loss and drafts, and to provide high security. There are a number of window design and construction techniques that are used in an effort to maximize both the desirable open and closed aspects of window. These include, without limitation, storm windows with superimposed exterior panes or protective panels, double-pane glass windows, inert gas captured between sealed spaced panes, overhangs and awnings, shutters, interior shades, Venetian blinds, curtains, and similar arrangements.

It would be desirable to provide a thermally insulating window assembly capable of controlling the passage of heat energy, possibly in the case of a large temperature difference across the window, exterior storms and similar challenges. Doing so would be helpful in maintaining a comfortable and stable interior temperature in the building. Energy costs are another consideration, and the cost associated with energy required to compensate for the heat conduction through a window should be factored into consideration of the total cost of the window.

It would therefore be desirable to provide a thermally insulative window apparatus that provides the openness of a window for some purposes while providing securely closed and/or energy conservation aspects for other purpose, and does so in a structure that is aesthetically pleasing and not unduly expensive.

### SUMMARY OF THE INVENTION

To address these and other needs, and in view of its purposes, the invention provides, according to one aspect, a window assembly comprising a window attached to a window frame carrying a jalousie configuration comprising a plurality of slats formed of a thermally insulating and/or security material that are pivotable to open or closed positions and when closed provide a barrier the thermal energy.

The slats can comprise a thermal insulation material. Additionally, in certain embodiments the slats are mounted to close substantially in a plane that is spaced from a glass window pane, sash or other window panel, thereby confining an air space when the jalousie slats and the window panel are closed. Pivoting of the jalousie slats, and optional opening and closing of the window panel, provide a range of possible open and closed states for the window assembly, wherein more or less air and light, and consequently more or less heat energy, can pass between indoor and outdoor spaces.

The window assembly can be opened for purposes of relatively unobstructed view and for admission of light, air and sunshine. The window assembly likewise can be closed, preferably considering a range of orientations of the jalousie slats, and in a preferred embodiment including opening or closing of an inside sash or casement with at least one glass pane. The states of closure that are permitted include limited operation of the slats as sunshades while permitting view through the window opening with the pane open or closed. The jalousie and/or window pane both preferably are capable of being manipulated, for admitting or blocking light and sunshine, for permitting or blocking air flow, for battening down as security against intrusion or severe storms, and for isolating a captured thermally insulating air space between a window pane and exterior jalousie slats.

In one embodiment, the insulative window assembly comprises a jalousie structure having slats made to include a thermal insulation material. The slats can be integrally molded of insulating material such as substantially rigid molded foam, or molded onto or otherwise affixed to an axle structure such as a metal tube with a square cross section that couples at non-round fittings to pivoting mechanisms in the window frame at one or both ends of each slat. Alternatively, the slats can comprise a hollow envelope such as plastic or sheet metal, with thermal insulation provided as a filling. The slats can be opaque for sun shading or translucent to admit light.

In another embodiment, the invention provides an insulative window assembly comprising a window attached to a window frame, the window comprising at least one and preferably two panes, at least one of which is movable with respect to the window frame, for example as slidably lapping sashes, and an insulative jalousie attached to the window frame. The jalousie comprises a plurality of parallel slats comprising foam insulation disposed within an aluminum casing. Each of the window and the insulative jalousie is surrounded by the window frame and situated between the indoor and outdoor surfaces of a building wall when the insulative jalousie is in a closed position. In respective embodiments, the closed jalousie slats can be substantially flush with the outer surface of the building wall when closed, and can be pivoted at an axis adjacent to a lateral edge of the slot so as to cantilever the slat outwardly when opened, serving as a sunshade. This arrangement is considered particularly apt for warm climates wherein one object is to keep the indoor area cool.

A number of additional aspects and embodiments will be made apparent in the following description of a range of nonlimiting examples and considerations according to which the preferred arrangements can be varied within the scope of the invention claimed.

### BRIEF DESCRIPTION OF THE DRAWINGS

The invention is best understood from the following detailed description when read in conjunction with the accompanying drawing. It is emphasized that, according to common practice, the various features of the drawing are not necessarily to scale. On the contrary, the dimensions of the various features are arbitrarily expanded or reduced for clarity. Like numerals denote like features throughout the specification and drawing.

FIG. 1 is a front elevation view of an exemplary insulative window apparatus according to the invention;

FIG. 2 is a rear perspective view of the exemplary insulative window assembly shown in FIG. 1;

FIG. 3 is a front elevation view of another exemplary insulative window apparatus according to the invention;

FIG. 4 is a front elevation view of yet another exemplary insulative window apparatus according to the invention;

FIG. 5 is a front elevation view of still another exemplary embodiment of the insulative window apparatus;

FIG. 6 is a perspective, front angle view of an exemplary insulative window apparatus in an open position according to an exemplary embodiment of the invention;

FIG. 7 is a cross-sectional side view of an exemplary insulative window apparatus in closed position according to an exemplary embodiment of the invention;

FIG. 8 is a cross-sectional side view of the exemplary insulative window apparatus shown in FIG. 7 but now shown in partially open position; and,

### DETAILED DESCRIPTION

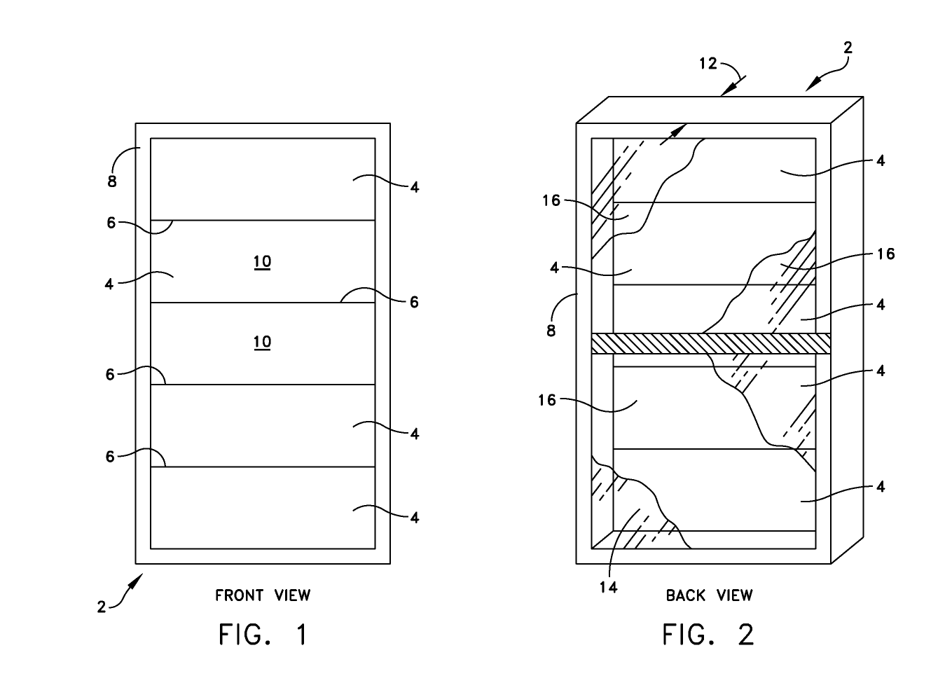

FIGS. 1 and 2 show an exemplary window apparatus 2 in a front or elevation view. The apparatus has aspects affecting light transmission and line-of-sight view, shading, and thermal insulation by way of conduction, convection or radiation. The window apparatus can be mounted in a number of specific ways, and in a given embodiment may include all or only parts of the aspects discussed herein as advantageous. By way of nonlimiting example, this discussion assumes that the view of FIG. 1 is representative as the apparatus is seen from the outdoor-side of a building, and might be, for example, an exterior window bounding a room in a residential living space.

Window apparatus 2 as shown defines a jalousie configuration and comprises parallel slats 4 carried on horizontal axes so as to pivot at journals at opposite sides of window frame 8, although other slat arrangements and orientations may be used as will be discussed with respect to other exemplary embodiments. Slats 4 include opposed longitudinal edges 6 and although the insulative jalousie is formed of five slats 4 in the illustrated embodiment of FIG. 1, it should be understood that this number is an example and the jalousie may include more or fewer slats in other exemplary embodiments.

FIG. 1 shows the insulative window apparatus 2 in its closed position from the outdoor side, meaning that the respective front surfaces 10 of slats 4 are pivoted substantially into plane parallel to the plane of the frame 8 and the wall in which the window is mounted. In this embodiment, the closed slats form a substantially planar surface in combination, but it is also possible that when fully closed the slats could remain slightly inclined relative to the plane of the frame, for example in a case where the slats are substantially flat and an upper slat overlaps a lower one when closed.

The rotation axes of the depicted slats 4 are generally horizontal, i.e., parallel to the ground (not shown), i.e., the longitudinal axes of slats 4 extend left to right in the illustrated embodiment of FIG. 1. Adjacent slats 4 preferably abut each other such that opposed longitudinal edges 6 either abut each other or preferably overlap slightly such that a superjacent slat 4 overlaps a subjacent slat 4.

Each slat 4 is advantageously pivotally coupled to window frame 8 via a drive mechanism disposed in one or both opposite members of the frame. The drive mechanism for moving the slats can be substantially as disclosed in U.S. Pat. Nos. 6,061,962 and 5,907,926, which are incorporated by reference in this disclosure. In general, the slats in those disclosures are attached via non-round fittings to a rotatable element in the frame having an eccentric crank arm. The crank arms of all the slats are coupled in a parallelogram linkage to a mechanism such as a geared rotatable handle. Operating the handle lifts or lowers an element coupled with respect to one of crank arms in the linkage. Thus, operating the handle causes the linkage to rotate all the slats clockwise or counterclockwise on their axes to close or open the jalousie as shown in FIGS. 1 and 2 from respective outdoor and indoor sides.

The linkage can rotate the slats open from the rotational position shown in FIGS. 1 and 2, e.g., such that the opposite lateral edges of each slat are moved closer to a horizontal plane parallel to the planes of each of the other slats. The slats preferably are rotatable up to 90° where the jalousie is fully open, or farther. When the slats are oriented edgewise, the slats provide a minimal obstruction to view by a person viewing inwardly or outwardly through window. When insulative window apparatus 2 is fully open, front surfaces 10 of slats 4 may be substantially horizontal, i.e. front surfaces 10 occupy parallel planes substantially parallel to the ground thereby opening vertical spaces between adjacent slats 4 for air flow, line of sight to the horizon, etc.

Each slat 4 is preferably thin and flat. The slats can be arranged to admit light when closed, e.g., comprising thermally insulated clear or translucent spaced glass panes, spaced from one another and sealed together around their edges. According to an aspect of the invention, the slats are structured to be thermally insulative, e.g., made of a thermally insulative material that might alternatively be opaque. Accordingly, the slats form a thermal barrier when closed.

The invention can be applied to a window wherein the insulative jalousie slats provide the only obstruction to airflow (i.e., the window opening need not have a separate glass pane or shutter or window screen apart from the jalousie). However, according to an alternative embodiment, the insulative jalousie slats can be provided in association with a glass pane or other barrier that provides an independent closure of the window opening to supplement the jalousie slats. In that case, the slats are spaced on the outdoor side from a panel comprising, for example, one or more glass panes. When the insulative jalousie slats are closed, a thermally insulated closed airspace is bounded by the slats, the glass panel and the frame.

FIG. 2 is a rear view of the exemplary insulative window apparatus 2 the opposite face being shown in FIG. 1. FIG. 2 is a perspective view showing that there is a thickness or depth 12 of insulative window apparatus 2 which is again shown in a slat-closed condition. In this embodiment, window 14, not visible in FIG. 1, includes two windowpanes 16 and one or both of windowpanes 16 may be slidable with respect to window frame 8 using a horizontal or vertical sliding sash. Other suitable means such as casement panes, pocket mounted panes and the like are also possible.

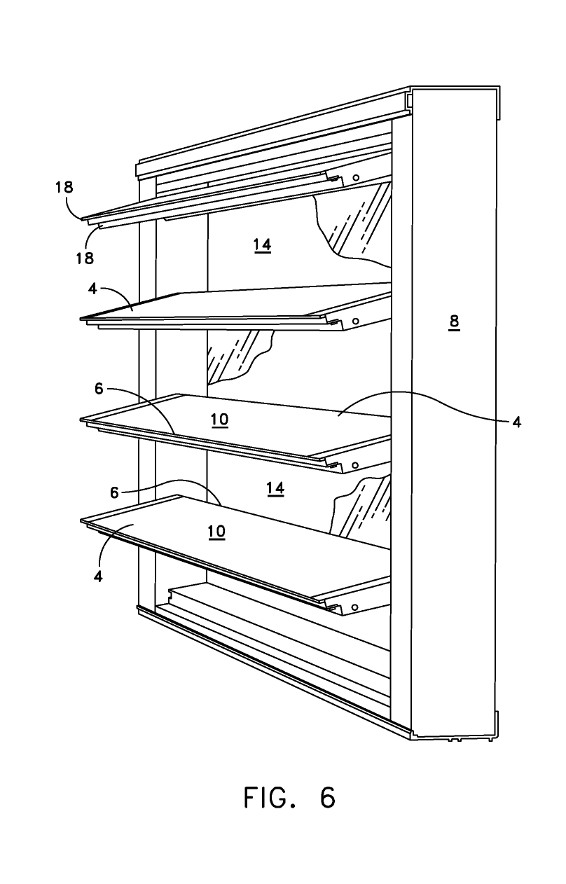

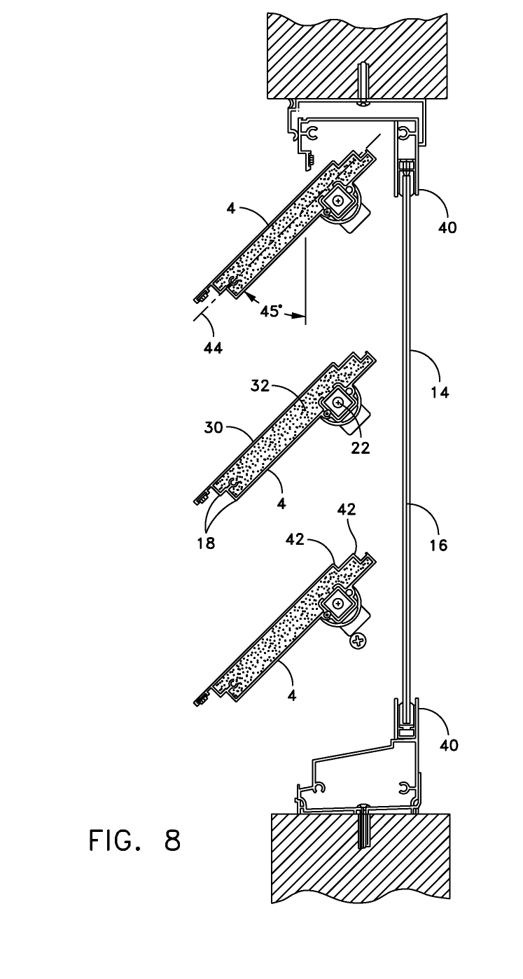

Depth 12 may be more or less as shown by the various exemplary embodiments. According to one embodiment, the slats can occupy a plane flush with the frame and with the outdoor side of the wall of the building in which the window is mounted. In that case, the depth 12 can be such as to place the opposite (indoor) side of the frame flush with the inner side of the wall. It is also possible to arrange either the indoor or outdoor side to protrude beyond the building wall. Increasing depth 12 while also increasing the lateral dimension of the slats, increases the extent to which the slats form sun-shading structures that are effective when the sun is high in the sky. Also, placing the slat pivot axes nearer to the upper lateral edge of the slats versus the lower lateral edge, cantilevers the slats into a sun-shading arrangement (e.g., see FIGS. 6 and 8).

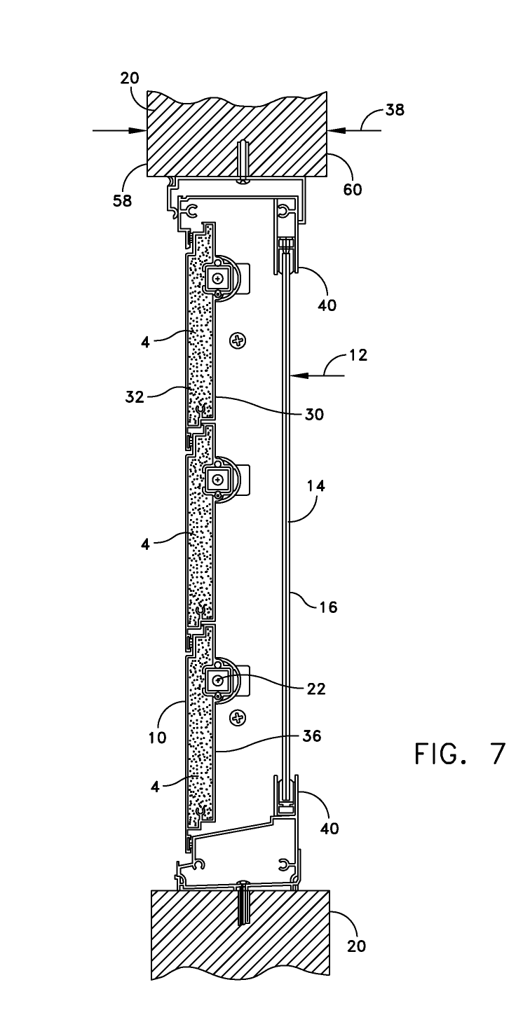

According to an advantageous embodiment, depth 12 may be slightly less than the depth of the wall within which insulative window apparatus 2 is installed. In the embodiments shown, the plane occupied by the slats when closed is near the outdoor edges of the frame and the window panes or panes 16 is at or adjacent to the indoor edges of the frame. (Although it should be appreciated that the invention is applicable to situations other than exterior windows.) These relative positions are shown in further detail in FIG. 7. Window 14, more particularly window pane(s) 16, may be made of glass, clear or translucent plastic or other suitable material for use in windows. The window pane 16 can be thermally insulating, e.g., with laminated plastic, spaced glass sealed around the edges, or another structure. Although the jalousie slates might be opaque or light transmissive, the window panes are preferably light transmissive, e.g., of clear glass. Accordingly the window 14 structure with panes 16 and the insulative jalousie formed of the plurality of insulative slats 4 are bounded by window frame 8, forming a hollow box.

In the illustrated embodiments, the frame of the window is permanently fixed in the window opening, i.e., nailed or otherwise fasted to studs or other structures that frame the window. It is also possible to embody the invention such that the frame in which the jalousie slates are carried is an inner frame and is removably affixed in the window opening, for example being attached by hinges to an outer frame that is permanently mounted in the opening (not shown in the drawings).

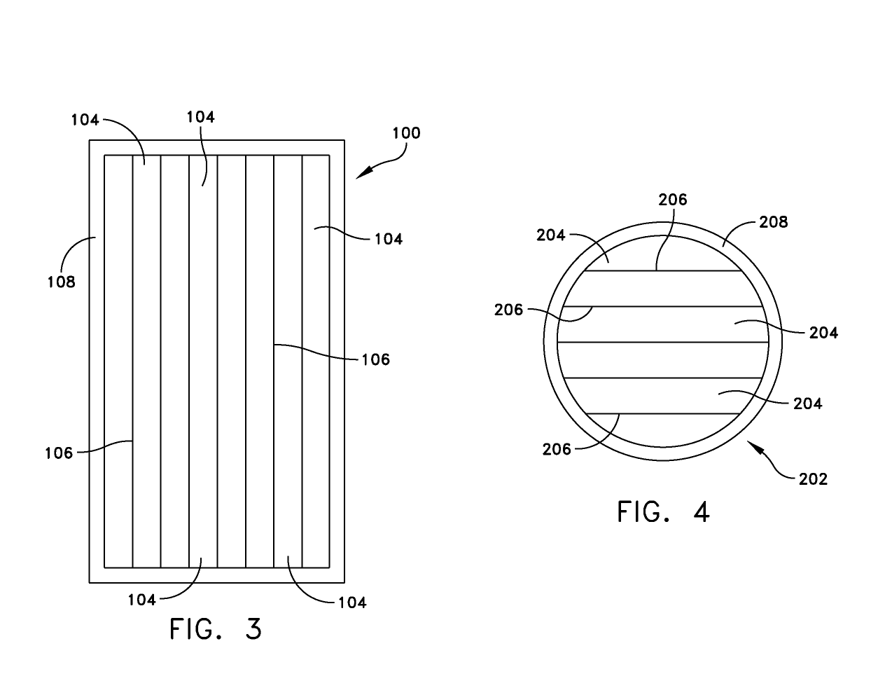

FIG. 3 shows another exemplary embodiment of a front view of an insulative window apparatus according to the invention. Insulative window apparatus 102 includes slats 104 with opposed edges 106. Slats 104 are parallel and generally extend in the vertical direction, i.e., the longitudinal axes of slats 104 are oriented vertically with respect to the ground. Slats 104 may be pivotally coupled to window frame 108 as described except for the different orientation of the rotation axes. Slats 104 are made of a thermally insulative material. Although not shown in FIG. 3, a window pane arrangement that can be fixed and sealed or displaceable for opening and closing independently of the jalousie slats, can be coupled to the rear portion of window frame 108. Eight slats 104 are shown in the exemplary embodiment illustrated in FIG. 3 to form a thermally insulative jalousie, which is exemplary only and more numerous laterally thinner slats 104 or less numerous wider ones may be used in other exemplary embodiments.

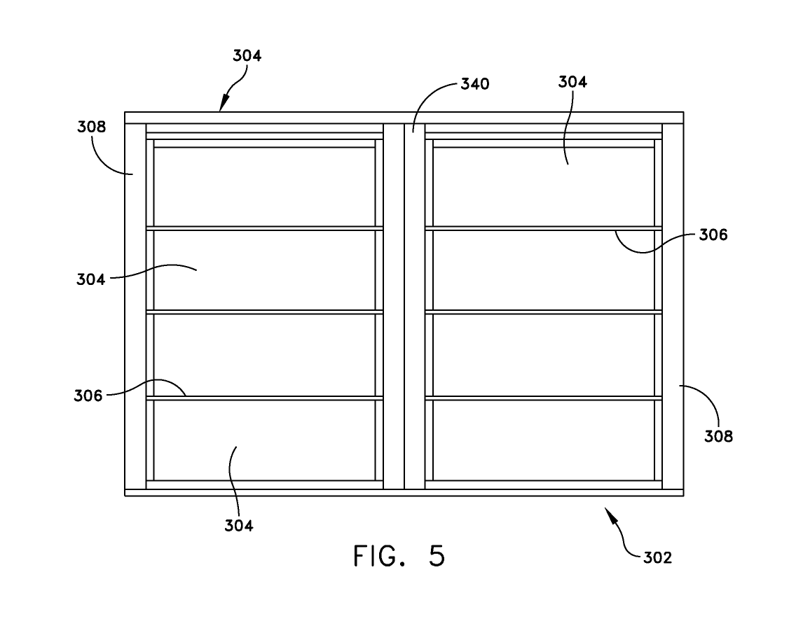

FIG. 4 is a plan front view showing another exemplary insulative window apparatus 202 having a round window frame 208 and with an insulated jalousie formed of a plurality of slats 204 bounded by opposed edges 206. As in the other exemplary embodiments, slats 204 are preferably made of a thermally insulative material. Although illustrated to show slats 204 extending in a generally horizontal direction, insulative window apparatus 202 may be installed such that slats 204 extend vertically.

FIG. 5 illustrates an embodiment of an insulative window apparatus 302 with a plurality of slats 304 that include opposed edges 306. As described above, the slats 304 are disposed in a window frame 308. A divider 340 separates two sets of horizontal slats 304, arranged side-by-side. In other words, two insulative jalousies are disposed laterally within common window frame 308, each preferably being independently controllable to tilt the slats. This exemplary embodiment may be particularly advantageous in larger window openings and may provide an intermediate setting with one of the insulative jalousies open and one closed.

FIG. 6 is a perspective view showing parallel slats 4 in an open position. Slats 4 are pivotally coupled to window frame 8 and window 14 is coupled to window frame 8. Slats 4 include opposed longitudinal edges 6. Ridges 18 are formed on the lower of opposed longitudinal edges 6 to provide a slight overlap of adjacent slats and a tight and sufficient thermally insulative seal when slats 4 are in closed position, i.e., when respective front surfaces 10 of slats 4 are substantially parallel to window 14 and orthogonal to the ground when insulative window apparatus 2 is installed in a vertical wall. This embodiment can be characterized by insulative slats comprising spaced or laminated glass panels to pass light, mounted on end brackets that couple to the linkage that rotates the slats. As mentioned, the slats are used together with a window pane structure 14 (visible between the slats in FIG. 6), to capture a thermal insulative air space when the slats and the window pane are closed.

It is possible to install the insulative window assembly as shown such that the respective slats face into the room and the window 14 portion faces outside, or vice versa. However, in order most effectively to exploit the sunshade aspects of the jalousie slats, it is preferable to place the glass on the inside and the slats on the outside. This arrangement also enables manual access to open and close the window panes, whereas panes that are beyond the jalousie slats would require a mechanism such as a casement operator with handle on the indoor side of the frame.

FIGS. 7 and 8 are cross-sectional views of a practical embodiment of insulative window apparatus 2, in this case comprising opaque slats that contain a thermally insulating material such as foamed polystyrene or another polymer, fiberglass batt or another material. The frame in this case is installed using screw anchors in a wall 20, such as a wood framing and/or concrete headers or the like . FIG. 7 shows the insulative window apparatus in closed position and FIG. 8 shows the insulative window apparatus 2 in partially open position. Suitable actuators and linkages such as shown in incorporated U.S. Pat. Nos. 6,061,962 and 5,907,926 can be employed for opening and closing the slats 4, i.e., cause slats 4 to pivot about respective axes 22, preferably by manual operation of the handle but potentially using a motorized operator.

Referring to FIGS. 7 and 8, slats 4 in this embodiment are generally flat and include casing 30 of sheet metal or alternatively a less thermally conductive plastic, and an insulative filler material 32. A sealed airspace can be used in lieu of a solid, foamed or fibrous filler material.

In one embodiment, casing 30 comprises a sheet metal such as aluminum or another metal or alloy. Casing 30 may be clad with or formed entirely of a polymer. Various alternative polymers, blown or solid or fibrous, fibrous mineral material such as fiberglass, and other thermally insulative materials are suitable. In one exemplary embodiment, filler material 32 comprises a foam insulation injected and set in situ.

In various exemplary embodiments, thermally insulative filler material 32 may be natural or manufactured, particular or solid or foamed or fibrous. Some examples are materials comprising one of cotton, fiberglass, silicon aerogel, carbon aerogel, polystyrene, polyicynene, polyurethane, polyisocyanurate, rockwool, slagwool, cork, hemp, straw and wool, or combination thereof.

In general, a higher insulating value is better than a lower one, subject to materials expense and the expected environment (e.g., expected temperature difference across the thermal boundaries). For example, the thermally insulating material of filter material 32 may have an insulating value of R-5 or greater. (Units of R-value may be expressed as Kelvin square meters per watt (K·m²/W)).

When the slats are closed, such as illustrated in FIG. 7, both front planar surfaces 10 and back planar surfaces 36 are substantially parallel to window 14 such that the plurality of slats 4 forms a generally flat outer closure. Insofar as depth 12 of insulative window assembly 2 may be made less than depth 38 of wall 20, finishing details such as framing and moldings can be installed in the available outward spaces. The details of wall 20, which may consist of a number of surfaces such as an inner and outer surface, and various beams, are conventional and need not be shown. However, the material of wall 20 may provide part of the frame 8, e.g., in an embodiment (not shown) wherein the jalousie structure is rigidly affixed to the wall 20 at the outdoor edge of the opening and window 14 is rigidly but independently affixed to the wall 20 at the indoor edge of the opening, i.e., an embodiment where wall 20 embodies part of the frame that connects the jalousie and window portions. Insulative window assembly 2 is disposed between outer wall surfaces 58, 60. According to another exemplary embodiment, depth 12 may be greater than depth 38.

In embodiments employing a window pane as a supplemental barrier independent of the jalousie, the window pane 16 of window 14 may be fixed immovably in the frame 8 or may slide within a track 40 as in the illustrated embodiment. The track may be arranged for lateral or vertical displacement. A window screen (not shown) can be provided to block insects. Other known mechanical and functional arrangements associated with windows can be used in addition to the elements described.

FIG. 8 clearly shows ridges 18,42 formed on opposed longitudinal edges 6 of slats 4. FIG. 8 shows insulative window assembly 2 in a partially open position, i.e., central axis 44 of slat 4 forms an angle of about 45° with the vertical. When in fully open position, central axis 44 preferably can rotate slat 4 to at least a horizontal orientation. A mechanical stop (not shown) can limit rotation to that angle or an even greater rotation angle may be permitted.

Referring to FIG. 7, it can be seen that from the front of the insulative window assembly 2, i.e., the left hand side of the illustration of FIG. 7, each slat 4 anteriorly overhangs or overlaps the adjacent subjacent slat 4. The ridges 18, 42 disposed on opposed longitudinal edges 6 of slats 4 mate with each other when closed, as shown in FIG. 7 to provide the overhang/overlap. In other exemplary embodiments, the respective longitudinal edges 6 of slats 4 may include other protuberances in one edge that mates with or is received within a channel or other receiving member in the opposed edge. For example, a rib, flange, or fin may be used in conjunction with a corresponding ridge, groove or other cavity or indentation.

In yet another embodiment, each slat 4 may be generally flat with opposed surfaces that curve toward each other and converge to form a tip at longitudinal edges 6. According to this exemplary embodiment, the thickness of slat 4 tapers near longitudinal edges 6 and respective longitudinal edges 6 of adjacent slats 4 may overlap when slats 4 are in closed position. Another possibility is a squared “S” shape in cross section where the upper edge of each lower slate hooks with the lower edge of the next upper slat and so on. The last slats similarly engage with the frame members. A jalousie arrangement with durable materials and such mechanical engagements between the slats is useful to provide protection against air borne debris in severe storms.

The preceding examples illustrate the principles of the invention. It will thus be appreciated that those skilled in the art will be able to devise various arrangements which, although not explicitly described or shown herein, embody the principles of the invention and are included within its spirit and scope.

The examples and associated conditional language found in this disclosure are for instruction in understanding the principles of the invention and demonstrate general and specific methods, structures and concepts that differ from the art. However, the invention should be construed in accordance with the appended claims and not limited to the embodiments disclosed as examples. Statements reciting principles, aspects, and embodiments of the invention the specific examples thereof, encompass structural and functional equivalents, including currently known equivalents and equivalents that may yet be developed to similarly perform the same function, regardless of structure.

In discussing the embodiments shown in the drawings and other examples, this description uses various relative terms such as “lower,” “upper,” “horizontal,” “vertical,” “above,” “below,” “up,” “down,” “top”and “bottom” as well as derivatives thereof (e.g., “horizontally,” “upwardly,” etc.). These terms should be construed to refer to the orientation as then described or as shown in the drawing under discussion, and do not imply that the invention is necessary limited to a similar orientation or relative arrangement of parts. Similarly, terms concerning attachments, coupling and the like, such as “coupled”, “connected” and “interconnected,” refer to a relationship wherein structures are secured or attached to one another either directly or indirectly through intervening structures, as well as both movable or rigid attachments or relationships, unless otherwise apparent from the disclosure and context.

The appended claims defining the invention should be construed broadly to include other variants and embodiments of the invention, which may be made by those skilled in the art without departing from the scope and range of equivalents of the invention as disclosed.

What is claimed is:

1. A window assembly comprising:
a window attached to a window frame configured for mounting in an opening in a building wall, and a jalousie structure attached to said window frame, said jalousie structure comprising a plurality of rotatable slats attached to close the space defined by the window frame, and wherein the slats comprise a thermally insulating material.

2. The window assembly as in claim 1, the window comprising a window panel that at least selectively closes a space defined by the window frame, at a position spaced from the slats, such that the window panel and the slats enclose an air space.

3. The window assembly as in claim 1, wherein the slats each comprise a casing formed of at least one of sheet metal and plastic.

4. The window assembly as in claim 1, wherein the slats each comprise a casing formed of at least one of sheet metal and plastic, wherein the casing has a hollow interior and further comprising a thermal insulation material in the hollow interior of the casing.

5. The window assembly as in claim 4, wherein each said slat comprises a casing containing at least one of a particulate, molded, foamed and fibrous insulating material.

6. The window assembly as in claim 4, wherein said thermally insulating material comprises at least one of cotton, fiberglass, silicon aerogel, carbon aerogel, polystyrene, polyicynene, polyurethane, polyisocyanurate, rockwool, slagwool, cork, hemp, straw and wool.

7. The window assembly as in claim 4, wherein said thermally insulating material has an R-value of at least R-5.

8. The window assembly as in claim 2, wherein the window panel comprises a glass pane coupled to said window frame and each of said window panel and said jalousie structure is bounded by said window frame.

9. The window assembly as in claim 8, wherein said window comprises at least one panel that is mounted in and movable relative to said window frame for opening and closing the space defined by the window frame.

10. The window assembly as in claim 1, wherein each said slat is pivotally coupled to said window frame and when pivoted to an open position is oriented to function as a sun shade relative to the space defined by the window frame.

11. The window assembly as in claim 10, wherein at least one of the slats comprises a structure complementary to an adjacent one of the slats such that said at least one and said adjacent one of the slats engage one another when pivoted to a closed position essentially parallel to a plane of said window.

12. The window assembly as in claim 1, wherein said window frame defines a shape that is one of square, rectangular, round and elliptical.

13. The window assembly as in claim 1, wherein each said slat has opposed ridged edges configured to overlap an adjacent slat such that respective said ridged edges of adjacent slats engage with each other to define a substantially flat closure at an outdoor side of said window frame when said jalousie is in a closed position, and wherein the window panel defines a closure on an indoor side of said window frame in a plane parallel to the substantially flat closure.

14. The window assembly as in claim 1, wherein a depth of said insulative window assembly is less than a depth of a wall within which said insulative window assembly is disposed, when said insulative jalousie is in closed position.

15. The window assembly as in claim 1, wherein the frame is divided to separate the slats into at least two independently operable jalousie structures that are laterally abutted with one another.

16. An insulative window assembly for an exterior building wall, comprising:
a window attached to a window frame configured for mounting in an opening in the building wall, said window comprising at least one windowpane that is movable for opening and closing the window in a plane; and,
a jalousie structure attached to said window frame at a space from the plane of the windowpane for likewise opening and closing the window;
wherein the jalousie structure comprises a plurality of parallel slats coupled to a pivoting mechanism, wherein the slats comprise thermal insulation;
wherein the slats are pivotable into a closed position for confining an airspace between the slats, the frame and the windowpane.

17. The insulative window assembly as in claim 17, wherein the slats are opaque and are cantilevered in the open position to shade the opening in the building wall.

18. The insulative window assembly as in claim 17, wherein the slats comprise thermally insulating glass panes.
